(19) United States
(12) Patent Application Publication
(10) Pub. No.: US 2020/0015342 A1
(43) Pub. Date: Jan. 9, 2020

(54) ELECTRICITY COLLECTING DEVICE AND METHOD

(71) Applicant: Graphene Composites Ltd, Sedgefield Stockton-on-Tees (GB)

(72) Inventor: Sandy Winthrop Chen, Balcombe West Sussex (GB)

(73) Assignee: Graphene Composites Ltd, Sedgefield Stockton-on-Tees (GB)

(21) Appl. No.: 16/491,095

(22) PCT Filed: Mar. 5, 2018
(86) PCT No.: PCT/GB2018/050553

§ 371 Date: Sep. 4, 2019

(30) Foreign Application Priority Data
Mar. 5, 2017 (GB) 1703512.2

(51) Int. Cl. H05F 7/00; H01B 1/24

(52) U.S. Cl. CPC H05F 7/00; H01B 1/24

(57) ABSTRACT

A device for collecting electricity from the atmosphere comprises: a collecting element adapted to draw electricity from the atmosphere; an electrically conductive element electrically connected to the collecting element for transmitting electricity collected by the collecting element to an output; and a support member capable of holding the collecting element in an elevated position, wherein the electrically conductive element comprises a composite structure extending at least partially along its length, the composite structure comprising a first layer comprising graphene.

### FIELD OF INVENTION

The present invention relates to a device, in particular an electricity collecting device for collecting electricity from the atmosphere.

### BACKGROUND TO THE INVENTION

Significant resources are currently spent on developing energy production and harvesting methods, with a view to improving efficiencies. Of particular interest is research into generation of electricity. Existing technologies can generally be separated into two categories: non-renewable sources, such as the burning of coal in a power plant, and renewable energy sources, such as the conversion of wind energy using wind turbines or the use of solar cells. One common features is that the aforementioned methods all produce electricity through conversion from other sources of energy, for instance, chemical, kinetic, or heat energy. Accordingly, these methods are inherently limited in efficiency by the energy losses incurred in converting the form of the energy.

Renewable energy sources also tend to have additional disadvantages in that they can rarely produce continuous energy. For instance, solar panels produce electrical energy from solar energy, or light, but cannot operate effectively under cloud cover or at night. Likewise, wind turbines rely on winds having a speed between a minimum and maximum limit, the latter being to avoid damage to the turbine. Hydroelectric dams, which generally provide more continuous electricity production, can still have their electricity production limited by a lack of upstream rainfall. Therefore, it would be advantageous to provide a source that is more consistent and/or that can provide a supply of electricity when the conditions mean that existing methods may otherwise be unable to provide a supply of electricity.

One potential source of energy that exists is the atmospheric electricity within the Earth's atmosphere. This atmospheric electricity may arise from several sources, including: 1) cosmic rays entering the Earth's atmosphere and ionising the molecules of air; 2) the solar wind, or charged particles from the sun, may also enter the Earth's upper atmosphere and also cause ionisation of air molecules; 3) the natural decay of radioactive elements creating ions; 4) electromagnetic generation occurring to due to the movement of air molecules through the Earth's magnetic field; 5) the production of static electricity through the collision of rising and falling ice and hail crystals, and 6) the accumulation of potential energy as water molecules (e.g. in clouds) tend to arrange themselves with the heavier electron-laden ends facing downwards.

Some efforts have been made to collect this electricity but difficulties arise in accessing these parts of the atmosphere and the transmission of current back to the surface or ground, particularly given the large distances involved. Improvements in the technology, and particularly the cabling and energy transfer methods are required.

### SUMMARY OF THE INVENTION

An aspect of the invention provides a device for collecting electricity from the atmosphere, which comprises a collecting element adapted to draw electricity from the atmosphere, an electrically conductive element electrically connected to the collecting element for transmitting electricity collected by the collecting element to an output, and a support member capable of holding the collecting element in an elevated position. The electrically conductive element comprises a composite structure extending at least partially along its length, the composite structure comprising a first layer comprising graphene.

Embodiments therefore provide an electricity collecting or harvesting device for collecting or drawing static electricity (more specifically, current) from the atmosphere. The device comprises a collecting element adapted to draw or collect electricity in the form of lightning or static electricity from the atmosphere and an electrically conductive member or element electrically connected or attached to the collecting element for transferring/transmitting electricity (i.e. current) collected by the collecting element to an output (e.g. for a storage device or transfer to an external circuit or system). Thus, the conductive member can extend between the collecting element and an output (e.g. located on the ground) and acts as a cable or conduit to transmit the electricity collected by the collection device to the output. The device further comprises a support element capable of holding the collecting element aloft or in an elevated position so that, in use, the support element holds the collecting element in the atmosphere and enable collection therefrom. The electrically conductive member comprises a composite structure extending at least partially along its length, the composite structure comprising a first layer comprising graphene. The composite may also comprise a second layer, such as a substrate onto which the graphene layer can be provided.

Embodiments thus provide a renewable and largely continuous means for harvesting electricity from the Earth's atmosphere through the collection of static electricity (e.g. in the form of static within clouds or lightning). In particular, due to the use of graphene, embodiments provide a device with an electrically conductive member that effectively and efficiently is able to transfer the current over the significant distances required in use between the electricity collecting element located in the atmosphere and whichever output is chosen for the current/electricity. Moreover, by virtue of the composite structure comprising graphene, which can form an exceptionally strong and lightweight layer, embodiments provide an element which can extend over large distances and be resistant to damage, for example from shear forces (e.g. wind, movement of the support element) or impacts (e.g. from debris), and which can help to support its own weight across the length of the element.

In particular, embodiments enable the collection of the electricity from a number of sources in the atmosphere. For example, lower levels of potential difference existing within a cloud, between clouds, or between a cloud and the ground, which may not usually lead to discharge, can still form a suitable source of electricity and at a more consistent, lower voltage. Further, while it is cosmic rays and solar wind that provide the most electrical energy within the atmosphere, clouds, and in particular, thunderclouds, provide the greatest concentration of electrical energy in the form of static electricity. Generally, the highest points of a cloud will be more positively charged than the bottommost points of a cloud; this is because, during the collisions, some water molecules become positively charged and rise, whereas the negatively charged molecules, which tend to be heavier are at the base of the cloud. Also, some molecules become arranged with their positively charged ends facing upwards and the heavier negatively charged ends facing downwards. Accordingly, as more water molecules accumulate (e.g. in a thunder cloud) differences can exist between the top and bottom of a cloud, and, in particular, between the bottom of a cloud and the surface of the Earth. When these potential differences reach a certain level, the strength of the electric field formed causes the air between the points of potential difference to undergo dielectric breakdown, wherein the air changes from a normally non-conductive state, to a conductive state. This dielectric breakdown can occur within the cloud itself, leading to a discharge (intra-cloud lightning) between the top and bottom of the cloud, or the dielectric breakdown can occur between the cloud and the ground, or between neighbouring clouds, leading to discharge between the cloud and ground, or between clouds (inter-cloud lightning). Both intra-cloud and inter-cloud lightning provide suitable sources of electricity for collection and re-use.

As set out above, the composite provided in the electrically conducting element comprises a first layer comprising graphene. A graphene layer is a two-dimensional allotrope of carbon with a single layer of graphene, which comprises a single planar sheet of sp2-hybridized carbon atoms. Graphene is known for its exceptionally high intrinsic strength, arising from this two-dimensional (2D) hexagonal lattice of covalently-bonded carbon atoms. Further, graphene also displays a number of other advantageous properties including high conductivity in the plane of the layer. Thus, embodiments will provide excellent conductivity by virtue of the graphene layer, particularly where the graphene extends along the entire electrically conducting element (e.g. between the collecting device and an output, or between electrical terminals connected to the collecting device and an input). Furthermore, the conductive elements will be relatively strong and damage resistant by virtue of the use of graphene in the structure. The conducting element generally takes the form of an elongate member and the first layer (and the other layers, where present) extends in the elongate axis. In other words, an axis defined by the plane of the first layer is the same or parallel to an axis defined by the elongate conducting element. In an embodiment, the first layer is a first surface layer and forms an outer surface of the electrically conductive element (or conductive member, where present).

As set out above, electricity from the atmosphere (or atmospheric electricity) includes electricity which is primarily in the form of static electricity. This static electricity may be concentrated in clouds, and in particular, storm clouds, but may also exist without the presence of clouds. In particular, the device may be adapted to provide a flow of current based on the potential difference between the electricity from the atmosphere and an output. In some embodiments, the device may be adapted to provide a substantially consistent current to the output. In other embodiments, the device may be adapted to provide an irregular current to the output, an irregular current occurring as a result of sudden high-intensity electrostatic discharges (lightning).

By “atmosphere” it is meant the air or environment above and surrounding the Earth's surface and thus, the device is adapted so that the electricity collecting device can be located in this region by virtue of the support element. This atmosphere is accordingly located above the ground or sea level (of the region it is around), for instance, between 0 and 100000 m above sea or ground level, or between 0 and 20000 m, 0 and 10000 m, 200 m and 10000 m, 500 m and 10000 m, 1000 m and 10000 m, or 2000 m and 10000 m above sea or ground level. In some embodiments, the support device is capable of holding or adapted to hold the collecting device at a height of at least 50 m above ground level, at least 200 m above ground level, at least 500 m above ground level or at least 1 km above ground level. By ground level, it is meant the ground adjacent the device or an output the device is connected to. In some embodiment, the conducting element (or the conductive member, where present) has a length of at least 20, at least 50 m, at least 100 m, at least 500 m or at least 1 k (for example, 20 m to 10 k, 20 m to 5 k, 20 m to 1 k, 100 m to 800 m, or 100 m to 500 m). Thus, in some embodiments, the device comprises an output located on the ground, with the conducting member extending between the collecting element and the output, and the support element holding the collecting member above the ground at a height. The collecting element may be adapted to draw the majority of the collected electricity from the atmosphere at a height above ground level listed above, but may also be adapted to draw a smaller amount of electricity from the atmosphere at a height above ground level below those listed above. It will be appreciated that ground level will vary depending on the environment (e.g. mountains) and the device may be provided on buildings such that the support element may be complemented by other means.

In an embodiment, the composite further comprises a second layer comprising an aerogel. Aerogels are a class of highly porous (typically nano-porous) solid materials with a very low density and which are very strong relative to their weight, making them useful in composites. As explained in more detail below, aerogels are formed by creating a gel and subsequently drying the gel to remove the liquid component (e.g. using supercritical drying). This creates the unique structure which contributes to the advantageous properties, including low density, high ability to transfer and dissipate impact forces and high electrical and heat insulating properties. This is at least in part due to the ability of these layers to spread impacts out in the plane of the layer, as well as through the height of the layer. In particular, the “nano-auxetic” structure of aerogels can provide them with shock-absorbing properties—the nanometre-sized tree-branch-like atomic structures spread the force of an impact along those branches, thereby rapidly dissipating the force of an impact. This also allows these layers provide vibration damping against vibrations caused by motion or airflow around the element, thereby reducing the risk of damage to the conducting element or any other part of the device.

The use of at least one layer comprising an aerogel in combination with a graphene layer leads to a number of advantageous properties enable the composite to form a high-strength and damage resistant, yet lightweight, cable or member which can extend across a large distance and conduct electricity efficiently. In particular, the combination of the aerogel layer and the graphene layer is advantageous, as the graphene layer provides a high-tensile electrically conductive layer (i.e. the tensile strength of the first layer (graphene-based) is stronger than that of the second layer (aerogel-based)) and at least partly reduces the force of any impact while the aerogel can absorb a substantial portion of the impact and reduce vibration damage and damage caused by shear forces, for example. This means that the composite structure leads to an element that is much stronger and more durable than previously could be developed.

Moreover, the aerogel is very light, particularly compared to its strength, and the graphene can be provided in thin layers while still providing excellent conductivity, which means that a composite comprising these two components can be exceptionally light but still very effective. In embodiments where the aerogel is an insulator, the aerogel also reduces the risk of damage as a result of high voltage transmission (e.g. from lighting strikes).

As mentioned above, aerogels are a class of highly porous (typically nano-porous) solid materials with a very low density. More particularly, an aerogel is an open-celled structure with a porosity of at least 50% (but preferably with a porosity of at least 95% air (e.g. 95 to 99.99%), optionally at least 99%) produced by forming a gel in solution and subsequently removing the liquid component of the gel using supercritical heating. As a result of the drying conditions, the solid portion of the gel maintains its structure as the liquid component is removed, thereby creating the porous body. The pores of an aerogel will typically have a pore size in the range of 0.1 to 100 nm, typically less than 20 nm. In embodiments, however, the aerogel can have a pore size in the range of 0.1 to 1000 nm, optionally 0.1 to 900 nm; 10 to 900 nm; 20 to 900 nm; 20 to 500 nm; or 20 to 100 nm. In embodiments, the porosity and pore size distributions of the aerogels can be measured using nitrogen absorption at 77K and applying the Brunauer, Emmit and Teller (BET) equation (see “Reporting Physisorption Data for Gas/Solid Systems” in Pure and Applied Chemistry, volume 57, page 603, (1985)). An aerogel can be formed from a number of materials, including silica, organic polymers (including polyimide, polystyrenes, polyurethanes, polyacrylates, epoxies), biologically-occurring polymers (e.g. gelatin, pectin), carbon (including carbon nanotubes), some metal oxides (e.g. iron or tin oxide), and some metals (e.g. copper or gold). In some embodiments, the aerogel is a cross-linked aerogel (e.g. the aerogel is formed from a cross-linked polymer, e.g. a cross-linked polyimide). Such aerogels are advantageously flexible and strong.

In an embodiment of the invention, the composite structure comprises a plurality of first layers each comprising graphene; and a plurality of second layers each comprising an aerogel, wherein the first and second layers alternate in the composite structure. This provides a composite structure with significant benefits. As set out above, use of a graphene-containing layer and an aerogel-containing layer leads to a high-strength, damage-resistant and lightweight composite. It has also been found that the more layers comprising alternating graphene and aerogel, the more effective this is. Moreover, the more layers there are, the more force the outer layers can absorb. This is thought to because each aerogel layer lessening the direct in-line force that is transmitted to the next graphene layer and each graphene layer, protects the adjacent aerogel layers from an impact (e.g. penetration from debris before the aerogel has dispersed sufficient force). Together, these enable the composite structure to disperse force to a greater extent and so the composite is much more durable.

In an embodiment, the composite structure comprises between 2 and 250 first layers and/or 2 and 250 second layers. For instance, the composite may comprise at least 5, at least 10 or, in some embodiments, at least 25 first and/or second layers. In some embodiments, there may be 10 to 200 layers, 25 to 150 layers, 50 to 125 layers. The number of first layers may be the same as the number of second layers. In some embodiments, the number of first layers is at least 5, at least 10 or, in some embodiments, at least 25. For example, there may be 10 to 100 layers or 25 to 50 first layers. It has been found that an increased number of layers can lead to a projectile being stopped earlier in the composite than in cases where there are fewer layers. This may be as a result of a shear thickening effect.

In an embodiment, at least one of the first layers consists essentially of graphene. In a further embodiment, each (all) of the first layers consist essentially of graphene. The term “consists essentially of . . . ” means that the first layer is almost entirely formed from graphene, but may contain minor quantities of other materials (for example, as a result of contamination or as a result of the method of forming the graphene layer). For example, at least one of the first layers, or each of the first layers, may be formed from 95% or greater graphene (by weight or by volume), preferably 98% or greater, more preferably 99% or greater, or even more preferably 99.9% or greater graphene.

In an embodiment, the first layer or, where there are multiple first layers, at least one of the first layers is a planar layer of graphene, which in embodiments extends in a plane parallel to a plane defined by the collecting element. In other words, the graphene is formed as a planar layer along the longitudinal axis of the collecting element (e.g. where the collecting element is an elongate member, the elongate axis). This is advantageous as the alignment of the graphene layer in this direction provides the most efficient orientation for conduction as the plane of the graphene extends between the collecting device and an output and because shear forces or impacts will be perpendicular or substantially perpendicular to the plane of the graphene and thus will have to overcome the graphene in its strongest direction. Where an aerogel-containing layer is present, any force will then subsequently impact the aerogel in a direction in which it can readily dissipate the force in the plane of the layer. Thus, these embodiments are particularly effective at absorbing an impact provided in a direction substantially perpendicular to the plane of the graphene layer. In an embodiment, the first layer or, where there are multiple first layers, each of the first layers is a planar layer of graphene extending in a plane parallel to a plane defined by an adjacent second layer. In an embodiment, the first layer or, where there are multiple first layers, each of the first layers is a mono-layer, a bi-layer or a tri-layer of graphene. In other words, the first layer comprises 1 atomic layer of graphene, 2 atomic layers or 3 atomic layer of graphene. Advantageously, the impact resistance of two or three atomic layers of graphene is significantly greater than a single atomic layer of graphene. In some embodiments, the first layer or, where there are multiple first layers, each first layer independently comprises at least 1 atomic layer of graphene, at least 5 atomic layers, at least 10 atomic layers of graphene. Preferably, in some embodiments, the first layer or, where there are multiple first layers, each first layer independently comprises from 1 atomic layer of graphene to 10 atomic layers of graphene. Both impact resistance and electrical conductivity have been observed to deteriorate with more layers, and by circa 10 layers the performance begins to decrease.

In an embodiment, the first layer or, where there are multiple first layers, each first layer independently has a thickness of from 0.34 nm to 20 μm. This can include a thickness of from 1 nm to 10 μm, 10 nm to 5 μm, 10 nm to 1 μm or 20 nm to 100 nm. In some embodiments, where there are multiple first layers, the first layers all have substantially the same thickness.

In some embodiments, the first layer or, where there are multiple first layers, at least one of the first layers comprises graphene in the form of graphene platelets. Graphene platelets may refer to small particles of graphene having an average particle size (i.e. a number average particle size) in the lateral dimension (i.e. at the greatest width across the face of the platelet) of at least 1 μm, optionally at least 2 μm, at least 5 μm (e.g. 1 to 10 μm, or 1 to 5 μm). The number average thickness of the platelets can be less than 200 nm, e.g. less than 100 nm, less than 50 nm. These measurements can all be measured by SEM. The platelets can comprise single or multiple layers of graphene. Graphene platelets may be in the form of pure graphene platelets or as graphene platelets in a matrix. In some cases, the graphene may be functionalised to improve compatibility with a solvent in the manufacturing process, for example by functionalising using plasma treatment. For example, in some embodiments, graphene may be functionalised using carboxyl groups. One example is a plasma treatment of “oxygen” functionalisation using the Hydale HDLPAS process, which is set out in WO 2010/142953 A1.

In some embodiments, the graphene layer is a holey graphene layer—i.e. graphene comprising pores or holes (from 1 nm to several hundred nm, e.g. 1 to 300 nm) therein. Such materials have been found to be high-conductive and their preparation is set out in U.S. Pat. No. 9,120,677, which is incorporated herein by reference.

In an embodiment where a second layer is present or multiple second layers are present, the second layer or each second layer independently has a thickness of 20 μm to 1000 μm. For example, this can include a thickness of from 50 μm to 800 μm, 100 μm to 500 μm or 125 μm to 250 μm. In some embodiments, where there are multiple second layers, the second layers all have substantially the same thickness.

In an embodiment, the composite structure further comprises a support or protective layer. The support or protective layer has a tensile strength greater than the tensile strength of the second layer, where present, and optionally also the graphene-containing layer and the other layers of the composite. Here, tensile strength may mean either the tensile stress, in Pascals, that can be supported by the layer before breaking, or the tensile load, in Newtons, that can be supported by the layer before breaking. For example, the support or protective layer may have a tensile strength of at least 200 MPa, at least 500 MPa, at least 1000 MPa; for example, 250 MPa to 5000 MPa; 1000 MPa to 5000 MPa). This can be measured, for example, by ASTM D7269 where the support or protective layer is a fibre-based layer and ASTM D3039 for polymer matrix based materials. In some embodiments, the tensile strength may be analogous to the ultimate tensile strength of the layer.

The use of a support layer having a greater tensile strength than the tensile strength of the other layers of the composite may allow for the composite to support greater tensile loads or have a reduced mass.

The support layer can help to support the remainder of the composite structure across its length and can assist in preventing damage to the conducting element/composite structure. This is particularly effective when in combination with the first layer and second layer, as the support layer provides a high-tensile layer which serves as a barrier to penetration and at least partly reduces the initial force of the impact before the rest of the structure can absorb a substantial portion of (or the remainder of) the impact. This reduces the likelihood of failure of aerogel layer under the initial peak force and thereby reduces the likelihood that that the aerogel will fracture. In turn, this allows the aerogel to absorb more of the impact and thereby provide better protection. Furthermore, this arrangement also reduces the strain on the graphene-containing layer or layers to act as protective components and thus reduces the risk of disruption in the continuity of the graphene layer as a result of damage.

In an embodiment, the support layer comprises a metal, an alloy, a polymer and/or a carbon containing material, preferably a polymer and/or a carbon-containing material. For example, the protective layer may comprise a high-tensile polymer and/or carbon-containing material (e.g. carbon fibre). In a further embodiment, the support layer comprises a high-tensile material selected from the group consisting of aramid (aromatic polyamide) fibres, aromatic polyamide fibres, boron fibres, ultra-high molecular weight polyethylene (e.g. fibre or sheets), poly(p-phenylene-2,6-benzobisoxazole) (PBO), polyhydroquinone-diimidazopyridine (PIPD) or combinations thereof. In an embodiment of the invention, the support layer comprises carbon nanotube (CNT) fibres (which in some embodiments may be combined with the previously mentioned other high-tensile materials). Here, the CNT fibres may be substantially aligned along a single axis, or along multiple axes. If the CNT fibres are substantially aligned with a single axis, or with multiple axes, they may be arranged in a substantially uniform or random manner. Here, uniform would refer to an arrangement where individual CNT fibres were substantially parallel, along their lengths, to adjacent fibres. Conversely, a random arrangement would refer to an arrangement where individual CNT fibres crossed other fibres at multiple points along their lengths. Alternatively, the CNT fibres may not be aligned with an axis, and may instead be randomly aligned. CNT fibres may have a tensile strength of between 10 GPa and 150 GPa, and may increase the overall tensile strength of the composite. In some embodiments, the CNT fibres may also be substantially continuous along the length of the composite.

Embodiments comprising a second (aerogel) layer and a protective layer are particularly advantageous where the second layer is arranged between the first layer and the protective layer as the aerogel layer is a strong insulator of both heat and current. In this way, the protective layer strengthens the electrically conductive element (or conductive member) and the aerogel layer protects the protective layer from damage due to the current running through the first layer. Such an arrangement is not always necessary, but can be advantageous in some embodiments, for example where the voltage is higher.

In an embodiment, the device comprises a conductive member which comprises both the collecting element and the electrically conductive element. In other words, the collecting element is essentially an extension of the electrically conductive element, the extension being adapted to collect electricity from the atmosphere. Thus, the collecting element may be integral with the electrically conductive element and may, for instance, comprise an external conductive region of the electrically conductive element, adapted to collect electricity from the atmosphere. For example, the first layer, or one of the first layers where there are a plurality of first layers may be at least partially located on the outer surface of the electrically conductive element to form the collecting element. The electrically conductive element may also comprise external insulating regions or external regions that are less conductive than the external conductive region. In some embodiments, the collecting element may comprise at least a portion of the electrically conductive element, wherein the portion has had an external insulating layer or coating removed. In embodiments where the collecting element is an extension of the electrically conductive element, this can reduce design and assembly complexity. The conductive member can, for example, be a cylindrical member and may take the form of a substantially cylindrical cable.

In an embodiment of the invention, the electrically conductive element is adapted such that, in use, the electrically conductive element extends from the collecting element to the ground. Here, ground may refer to an electrically conductive sink at ground level (i.e. less than 50 metres above or below sea level). The ground may refer to a solid ground, for instance, earth, soil, or a dedicated grounding device, but can also refer to non-solid grounds, for instance, bodies of water. In some embodiments, the electrically conductive element may directly extend from the collecting element to the ground. In other embodiments, the electrically conductive element may indirectly extend from the collecting element to the ground, for instance, there may be a further transmission element between the electrically conductive element and the ground.

In an embodiment of the invention, the electrically conductive element comprises a terminal portion for connecting to an output and wherein the composite structure extends from the collecting element to the terminal portion. In some embodiments, the terminal portion provides for a permanent connection to the output. In other embodiments, the terminal portion provides for a non-permanent, or releasable connection, to the output.

In an embodiment of the invention, the device further comprises an energy storage device, wherein the electrically conductive element is electrically connected to the energy storage device so as to transmit at least a portion of the electricity collected from the atmosphere to the energy storage device. The energy storage device thus acts as an output for the device. The use of an energy storage device may allow for greater quantities of electricity to be collected and stored. Additionally, the use of an energy storage device may provide for a voltage smoothing effect, wherein the voltage level at the output may be more uniform than the voltage level at the collecting element. Here, voltage level would refer to the potential difference between the measurement point and a common reference point, for instance, the ground.

In an embodiment of the invention, the energy storage device is a capacitor array or an ultra-capacitor array. The use of capacitors or ultra-capacitors may be advantageous as they provide a means for electrical storage having a high charge and discharge rate. This may be particularly advantageous if the device is adapted to collect electricity occurring from sudden high-intensity electrostatic discharges (lightning). In some embodiments, the ultra-capacitors used in the ultra-capacitor array comprise graphene, for instance, curved graphene as disclosed in European Patent Application EP2564404. The ultra-capacitors may be any commercially available ultra-capacitor, and may, individually, have a capacitance of between 500 and 4000 Farads, and a peak charge and discharge rate of 500 to 4000 Amps, at a mass of between 0.1 and 0.5 kg. The ultra-capacitors may individually have an operating voltage of between 2.5 V and 3.5 V. The operating voltage of the ultra-capacitor array can be increased if the ultra-capacitors are used in a series configuration.

In an embodiment of the invention, the support member is a lift providing support member. A lift providing support member could mean any device capable of providing a lift force and, in particular, capable of raising or lowering its altitude. A lift providing support member could comprise, for instance, an active device such as an aircraft, or a passive device having a density less than the surrounding atmosphere. A passive device may only be capable of raising or lowering its altitude in response to changes in its density, the density of the atmosphere, or the mass that it supports. Here, aircraft could include airplanes, helicopters, or drones.

In an embodiment of the invention, the lift providing support member is an inflatable member. An inflatable member provides lift through buoyancy. In particular, a lift force is provided if the inflatable member is less dense than the surrounding atmosphere. In practice, inflatable members are passive devices, referring to the above definitions. However, certain properties of the inflatable member may be actively managed to vary the lift force provided. An entirely passive inflatable member could, for instance, be a balloon filled with a lightweight gas such as helium or hydrogen, or evacuated of all matter. Alternatively, inflatable members may include hot air balloons, blimps and airships, which may have means to control their overall density, among other characteristics. In an embodiment, the lift providing support member is a high-altitude balloon (e.g. a weather or sounding balloon).

In the above embodiments of the composite structure, the composite structure can comprise a number of layers (e.g. multiple graphene layers, graphene and aerogel-containing layers, etc.). Each consecutive layer may be directly or indirectly in contact with the other layers of the composite structure. For example, the composite structure may further comprise additional layers provided between a first layer and a second layer. The composite structure may also comprise additional layers provided on top (e.g. on the upper surface of the uppermost layer) or bottom (e.g. on the lower surface of the lowermost layer) of the composite structure. Each layer may fully cover a surface of an adjacent layer or may only partially cover the surface of an adjacent layer. In some embodiments, a layer may extend beyond the edge of an adjacent layer. The layers may also each include further components or additives. For example, in some embodiments the graphene layer may comprise a polymer (e.g. polyurethane). In the composite structure, the layers may each have a thin sheet structure—i.e. with two larger opposing faces connected by four smaller edges.

In a second aspect of the invention, there is provided a method of collecting electricity from the atmosphere, which comprises: providing a device according to any embodiments of the first aspect; drawing electricity from the atmosphere using the collecting element; and transmitting electricity collected by the collecting element along the electrically conductive element to an output.

### BRIEF DESCRIPTION OF THE DRAWINGS

Embodiments of the invention will now be described with reference to the accompanying figures, in which:

FIG. 1 shows an embodiment of the device according to the invention;

FIGS. 2a and 2b show transverse cross-sections through a composite structure according to an embodiment of the invention;

FIG. 3 shows a radial cross-section through a composite structure according to an embodiment of the invention;

FIG. 4 shows another embodiment of a device according to the invention;

FIG. 5 shows a side view of a composite structure for use in a device according to the invention;

FIG. 6a shows an SEM image of a composite structure for use in a device according to the invention;

FIG. 7a shows a composite structure according to an embodiment of the invention;

FIG. 7b shows another composite structure according to an embodiment of the invention;

FIG. 7c shows another composite structure according to an embodiment of the invention;

FIGS. 8a and 8b show another embodiment of a composite structure according to the invention from side and side perspective views, respectively; and

FIG. 9 shows another embodiment of a composite structure according to the invention from a side view.

Like components are given like reference numerals. For example, a graphene layer may be referred to as “151a”, “251” or “351”. Further, in the figures where composite structures are shown, it should be appreciated that the thicknesses of the layers are purely representative (with the exception of those in which a photograph or SEM image is provided).

### DETAILED DESCRIPTION OF THE INVENTION

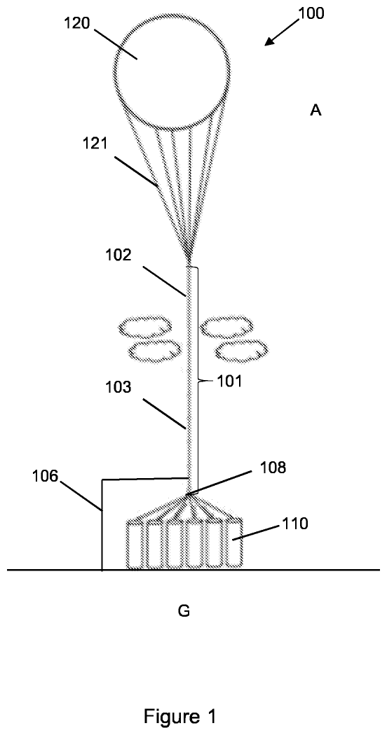

A first embodiment of the invention is shown in FIG. 1 in the form of device 100 for collecting electricity from the atmosphere A. The device 100 comprises an electrically conductive member 101 in the form of a cable which comprises a collecting element 102 adapted to draw electricity from the atmosphere A and an electrically conductive element 103, which electrically connects the collecting element 102 to an output 108. The electrically conductive member 101, and specifically the collecting element 102, is held aloft in the atmosphere above the ground G (i.e. the Earth's surface) by a hydrogen-filled latex weather balloon 120 which is tethered to the conductive member 101 by a series of shroud lines 121, with the electrically conductive element 103 extending from the collecting element 102 located in the atmosphere A back to the ground G, where the output 108 is located. In this embodiment, the output 108 is the input terminal of ultra-capacitor array 110 (see EP2564404 for an example suitable ultra-capacitor array).

The conductive member 101 in this embodiment is a cable formed of a composite structure 150, which structure 150 extends along the length of the cable from a terminal for connecting to the output 108 located on the ground G to the opposing end of the conductive member 101 located in the atmosphere A. The composite structure 150 in this embodiment thus forms part of both the collecting element 102 and the conducting element 103.

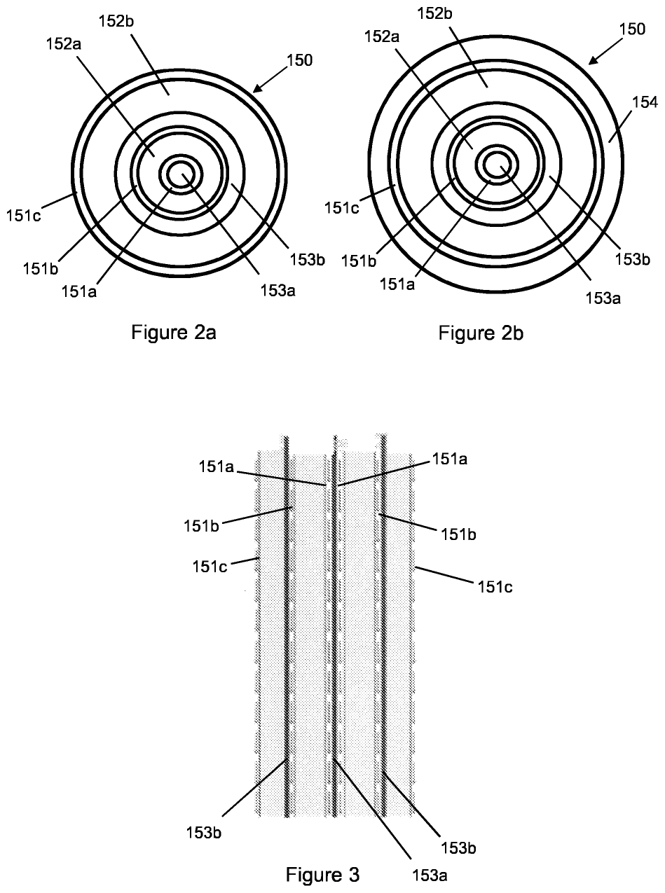

The composite structure 150 can be seen in more detail in FIG. 2a, which shows a cross-section through the diameter of the collecting element 102. A radial cross-section through the composite structure 150 is also shown in FIG. 3. As can be seen, the composite structure 150 comprises a number of layers 151a-c, 152a-b 153a-b arranged as a series of concentric rings which repeat through the cross-section of the composite structure 150. The innermost layer in the structure 150 on this embodiment this is a support layer 153a in the form of carbon nanotube fibre layer (CNT). This provides a high-strength backbone through the composite structure 150. Immediately adjacent the central support layer 153a is a first layer 151a in the form of a graphene layer which is provided onto a surface a second layer 152a formed of a polyimide aerogel film. Onto the other side of the first aerogel layer 152a is provided another graphene layer 151b. The structure then continues (moving out from the graphene layer 151b) with a further CNT layer 153b, a further aerogel layer 152b and a final outer graphene layer 151b. Although not visible in FIG. 2a, the end of the cable 101 provides an exposed end surface whereby the inner graphene layers 151a, 151b, are exposed to the atmosphere such that current can pass along these layers 151a, 151b, as well as the outmost graphene layer 151c. This composite structure 150 is particularly advantageous as the materials used provide a flexible, lightweight and damage-resistant conducting member 101 which can extend over very long distances. In particular, the high-strength support layers 153a,b, the aerogel layers 152a,b and the graphene layers 151a-c all contribute to supporting the weight of the structure 150 along the length of the conductive member 101 and each are able to contribute to prevent damage as a result of shear forces (e.g. as a result of movement of the conductive member 101, for example when moving into position or under the action of wind) and impacts from debris, ice, etc.

This configuration of layers continues throughout the length of the composite structure 150 to provide a continuous set of graphene layers 151a-c which extend along the length of the conductive member 101. In addition to this, the composite structure 150 includes an additional layer in the form of an insulating layer 154 which surrounds the remaining layers of the composite structure 150 along the part of the conductive member 101 defining the conducting element 103. This insulating layer 154 reduces the risk of people or property coming into contact with the current flowing through the conductive member and thus acts as a protective shield. A cross-section of the conductive member 101 in the conducting element 103 region is shown in FIG. 2b, where the insulating layer 154 is visible.

In use, the weather balloon 120 is located at an altitude of approximately eight miles, such that the collecting element 102 is located approximately at cloud level. If resistive heat and electrical losses are ignored, the collecting element 102 is at substantially the same voltage level as the output 108 prior to use. Accordingly, when the collecting element 101 is not collecting electricity, the voltage level at the collecting element 102 and output 108 is substantially the same as the ground G to which the ultra-capacitor array 110 is connected. When the collecting element 101 is collecting electricity, the voltage level at the collecting element 101 and output 108 is substantially the same as the static electricity source. Accordingly, if the collecting element 102 is not collecting electricity there is no potential difference across the ultra-capacitor array 110, and no current flows into the array 110. When the collecting element 102 is collecting electricity, there is a potential difference across the ultra-capacitor array 110 and current flows into the array 110, thereby storing electrical energy in the array 110. In this embodiment, the exposed outermost graphene layer 151c and the ends of the inner graphene layers 151a, 151b provide highly conductive layers along which current can travel to the output 108 efficiently and it is these parts which harvest or collect the static electricity by providing a conductive surface across which there is the potential difference.

In this embodiment, to transfer energy to the electrical grid (not shown), the ultra-capacitor array 110 has its electrical connections (i.e. at input and output terminals) switched from the electrically conductive element 102 and the ground G (as it is connected when collecting electricity) to an electrical grid connection (not shown). When switching, the configuration of ultra-capacitors 110 can be adapted to provide the desired output voltage, for instance, a greater number of individual ultra-capacitors may be in parallel when transferring electricity to the grid than when collecting electricity, which would provide a step-down in voltage. The electrical grid connection comprises an inverter for converting from direct current to alternating current at a frequency suitable for the grid. In some scenarios, a potential difference between a static electricity source and the output 108 may be too great, and electrical damage by overcurrent or overvoltage may be prevented by shunting the electrical energy directly to ground G by the secondary conductive route providing an earthing point 106. It will be appreciated that the maximum energy flow along the conductive member 101 is limited by the take-up rate of the ultra-capacitors 110 and, therefore, the overflow would be transmitted into the earthing point 106 or dispersed as with existing lightning rods. In this embodiment, secondary conductive route to earthing point 106 is opened automatically in response to potential differences over a certain threshold.

Accordingly, the device 100 in this embodiment can be used to harvest the static electricity from the atmosphere and thereby provides a clean and renewable source of energy. Moreover, the electricity harvesting device 100 can also be used to harvest much higher levels of electricity by acting as a grounding rod for lightning. With the collecting element 102 located in highly charged clouds, the conductive member 101 provides a new path of least resistance for lightning, both within the clouds and between the clouds and the ground G. Moreover, the composite structure 150 is particularly effective for this function as the high voltage passing through the graphene layers 151a-c can be contained effectively within these layers by the surrounding aerogel layers 152a,b, which are effective insulators and thus reduce the risk of damage to other parts of the composite. Further, the presence of a secondary conductive route 106 helps to ensure that electrical components at the output 108 are protected during high voltage transmission.

As set out above, the composite structure 150 in this embodiment comprises a number of graphene layers 151a-c and a number of other layers 152a,b, 153a,b. This can be constructed by using atomic deposition to provide a layer of graphene (the layer having multiple graphene layers) on a flexible substrate, followed by applying this layer of graphene to the flexible polyimide aerogel and repeating on the other side of the aerogel. This sub-unit can then be rolled around the central CNT layer 153b and the process repeated for the other layers.

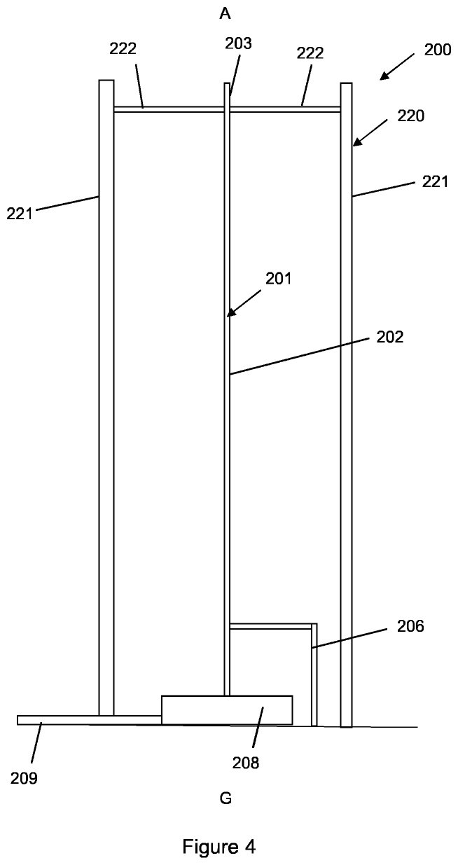

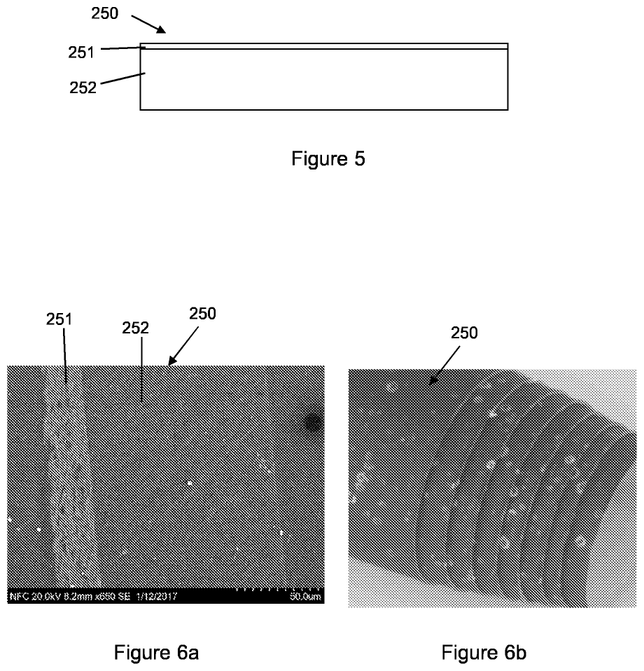

A second embodiment of the invention is shown in FIG. 4 in which there is an electricity collecting device 200. This device 200 comprises a support frame 220 formed of two upright support masts 221 from each of which a support arm 222 extends out towards the other mast 221. The support arms 222 both engage and hold a conductive member 201 in the atmosphere A between the two masts 220 so that electricity can be collected using the conductive member 201. In this embodiment, the support frame 220 is insulated from the ground G so that electricity does not pass through the support frame 220. The conductive member 201 comprises a composite material 250 which comprises an aerogel layer 252 onto which a graphene layer 251 is formed. This sheet of material (which is shown in FIG. 5) is then rolled over onto itself to form a spiraling circular conductive member 201. An SEM image of the composite material 250 in its unrolled configuration is shown in FIG. 6a and an SEM image of the composite material 250 in a partially rolled configuration is shown in FIG. 6b. This composite material runs throughout the whole length of the conductive member 201 and defines both a collecting element or portion 203 located at the top of the conductive member and a conducting element or portion 203. Thus, the collecting element 203 acts as a means for conducting and collecting electricity from the atmosphere A.

The device 200 in this embodiment is designed to be located at an elevated position, for example on top of a building or in a region with a high altitude (i.e. above sea level) so that the conductive member 201 can have a reduced length but so that the collecting element 202 is still located in an part of the atmosphere containing atmospheric electricity (or potentially, under particular conditions, containing atmospheric electricity, for example, once clouds begin to form). As with the embodiment of FIG. 1, this device 200 is arranged to create a potential difference across the conductive member 201 so that current can flow to an output 208 and subsequently be provided to an external circuit via wire 209. A secondary overflow earth 206 is also provided to avoid damage to the components of the device 200.

In this embodiment, the composite structure 250 is provided by forming a graphene layer 251 on a flexible polyimide aerogel layer 252. In this case, the graphene is disposed onto the aerogel substrate using graphene platelets or powder provided in the form of an ink. This is achieved by dispersing graphene platelets in a solvent, applying the ink to the surface of the aerogel and removing the solvent to leave a layer of graphene platelets on the surface. This allows for the simple and relatively inexpensive application of a highly-conductive layer of graphene to the aerogel. Moreover, no further additives are required in the layer (e.g. a matrix). Alternatively, a method of providing the graphene layer 251 on the aerogel layer 252 can include the use of mill rolling, such as applying the graphene powder or platelets using a three-roll mill. This can allow for layering of the graphene without the need for solvents and in a relatively high-throughput manner.

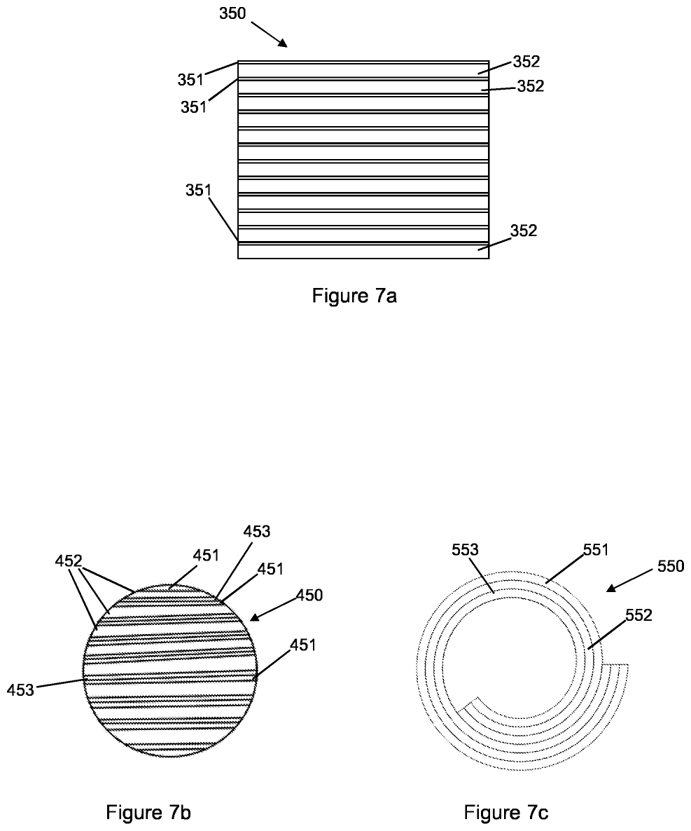

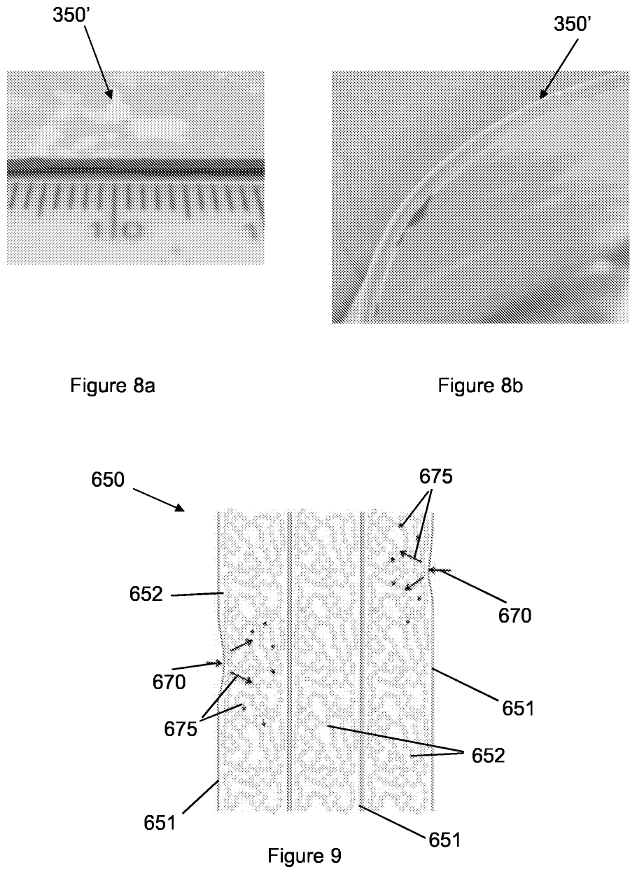

Alternative composite structures will now be described with reference to FIGS. 7a to c. Referring now to FIG. 7a, a cross-section of a conductive element 303 is shown, which comprises a composite structure 350 having multiple first layers 351 and multiple second layers 352, which alternate through the structure. The first layers 351 comprise graphene platelets formed into a uniform graphene layer using a graphene ink solution, which is dried onto a substrate. The second layers 352 are comprised of an aerogel. This structure is very lightweight due to the use of aerogel and graphene only and thus provides a composite 350 that can be used in conductive elements 303 over very large distances without requiring significant support. Rather than being provided as a circular cable, as with the previous embodiments, the composite structure 350 in this embodiment can be used as a square or rectangular conductive member and/or conducting element. An example of such a composite structure (labelled 350′) is shown in FIGS. 8a and 8b. In FIG. 8b, it is clear that this structure is flexible.

Referring now to FIG. 7b, a cross-section of a conductive element 403 is shown, which comprises a composite structure 450 having multiple first layers 451, second layers 452, and support layers 453. The first layers 451 comprise graphene platelets formed into a graphene layer. The second layers 452 are flexible polyimide aerogel layers. The support layers 453 are formed from CNT. As can be seen, the first layers 451, second layers 452, and support layers 453 form a repeating structure wherein the support layer 453 of one repeat unit is adjacent to the first layer 451 of the next repeat unit. In this embodiment, the first layers 451 are bonded to the adjacent second layer 452, which are in turn bonded to the adjacent support layer 453. The support layers 453 of one repeat unit are bonded on one surface to the coincident surface of the first layers 451 of the next repeat unit.

A further embodiment is shown in FIG. 7. In this embodiment, the composite structure 550 of a conductive element 503 is shown. In this embodiment, the composite structure 550 comprises a first layer 551, second layer 552, and support layer 553 which have been rolled over so as to form a series of overlapping layers. The second layer 552 is an aerogel layer. The support layer 553 is formed of a carbon nanotube fibre layer (CNT). As can be seen in FIG. 7c, each of the first layer 551, second layer 552, and support layer 553, is therefore continuous. In this embodiment, the first layer 551 is bonded to the second layer 552, which is in turn bonded to the support layer 553. Where the layers are overlapped, the inner surface of support layer 553 is in proximity to the outer surface of first layer 551, such that an air gap exists between the surfaces. In this embodiment, no bonding occurs between the inner surface of support layer 553 and the outer surface of first layer 551. This arrangement is provides a composite structure that is easy to manufacture and which provides substantial strength due to the overlapping layers and the materials used. This also provides a large graphene surface area, which leads to a high capacity for current to pass through the composite structure 550.

Manufacture of the composite structure 550 can, in some embodiments, comprise 1) depositing, by Atomic Layer Deposition (ALD), Chemical Vapour Deposition (CVD), vacuum deposition, or Physical Vapour Deposition (PVD) including sputtering or slot die processes, at least one graphene layer onto an aerogel layer to form a graphene/aerogel composite, 2) bonding at least one carbon nanotube fibre layer to the graphene/aerogel composite, such that the fibres are oriented lengthwise along the composite, using processes that involve vacuum bonding, including use of heat and pressure (for instance, roll presses), and such as to form a graphene/aerogel/carbon nanotube composite, 3) rolling the graphene/aerogel/carbon nanotube composite along the width of the composite, such that the rolling axis is oriented lengthwise along the composite, and such that the graphene layer is the outermost layer of the rolled laminate structure, and 4) bonding the rolled composite such that it remains in a rolled state. In some embodiments, the fabrication process described above may additionally include the step of bonding a further aerogel layer to the carbon nanotube fibre layer.

Although in some of the embodiments described above, the graphene layers are provided in the form of graphene platelets formed into a layer or by building up graphene layers using a thin-film deposition method, other types of graphene or manufacturing methods can be used. In some embodiments, the graphene layer is a holey graphene layer—i.e. graphene comprising pores or holes (from 1 nm to several hundred nm, e.g. 1 to 300 nm) therein. Such materials have been found to be high-conductive and their preparation is set out in U.S. Pat. No. 9,120,677, which is incorporated herein by reference. To form a layer of holey graphene that can be used in the composite structures of the invention, mill rolling can be used, such as dispersion using a three-roll mill. This can allow for dispersion of the graphene without the need for solvents and in a relatively high-throughput manner. In particular, one method of forming the layer is to form a holey graphene layer onto a polymer film substrate using a mill rolling technique. The materials disclosed in U.S. Pat. No. 9,120,677 also include holey graphene carbon nanotubes (CNT), which can also be used as the CNT of the support layer.

Although the composite structures described in respect of the above embodiments extends substantially along the entire length of the respective conductive members, with the only exception being a terminal portion for connecting to an output, the composite structures in some embodiments may only extend partially along the length. Preferably, the composite structure extends at least 30% of the length of the conductive member and/or conducting element, at least 50%, at least 75%, at least 90% or at least 95%. In some embodiments, the composite structure extends along substantially all of the length of the conductive member and/or conducting element. By substantially all, it is meant that the composite structure extends along all of the length of the conductive member and/or conducting element but there may be some additional components in the form of end terminals which form part of the length of the conductive member. Furthermore, the composite structure extending along the conductive member and/or conducting element may be a single, continuous structure or may be comprised of a series of individual composite structures which are in electrical connection (for example, bonded together or held together). The latter may facilitate manufacture.

A further embodiment is shown in FIG. 9, which illustrates why composites comprising both graphene and aerogel are particularly effective for providing long conductive members (e.g. cables or wires) for use in devices according to the invention. In this embodiment, there is a composite structure 650 in a transverse cross-section. The structure 650 comprises a number of aerogel layers 652 which alternate with graphene layers 652. This structure 650 provides a useful backbone for a cable as the aerogel and graphene present in the first 651 and second 652 layers provides the strength and resilience required to function where significant shear forces 670 (dissipated in the structure 650 by the mechanisms depicted by arrows 675) will be acting on the elongate designs. Similarly, vibrations are dampened and absorbed by the aerogel layers 652 in the structure so as to minimise vibration through the structure.

As set out above, manufacturing the above laminates can be carried out by a number of methods. For example, where the graphene is a planar layer, the graphene may be deposited using a thin-film deposition method or, alternatively, by using an exfoliation technique. In one embodiment, a roll-to-roll manufacturing process is used. In particular, a flexible aerogel layer (for example, a cross-linked aerogel) is provided on a flexible substrate (e.g. a polymeric substrate film) and a graphene layer is formed on the aerogel using a thin film deposition method. In another embodiment, graphene can be formed using an epitaxial formation of graphene on a flexible metal substrate, which can then be layered with a flexible aerogel. Thus, graphene can be grown on a metal (e.g. ruthenium) and placed on aerogel, before these are removed from the substrate and used to construct a composite structure comprising multiple layers of graphene and aerogel. In another embodiment, the graphene layer may be formed as an ink which is used to coat an aerogel layer or film. In this way, the graphene, in the form of platelets or a powder, for example, can be readily applied to a number of substrates in a relatively straightforward manufacturing process. The other components making up the ink may remain in the graphene layer or may be removed after the layer has been applied.

### EXAMPLES

In addition to the examples above, further specific examples of composite structures for use in the components above are provided below:

### Example 1

A 125 μm flexible polyimide aerogel layer (AeroZero 125 micrometer polyimide aerogel film; BlueShift Inc (US)) was cut to size and coated with a 20 μm layer of graphene (Elicarb graphene powder; Thomas Swan & Co Ltd UK Product No. PR0953) in a polyurethane matrix (PX30; Xencast UK Flexible Series PU Resin system. Manufacturer reported properties: Hardness of 30-35 (Shore A); Tensile strength 0.7-1.2 MPa; Elongation 100-155% at break; Tear Strength 3.5-3.8 kN/m) using a slot die process. After coating, the graphene/polyurethane layer was left to cure and subsequently cut to size.

The graphene/polyurethane layer comprised 5 wt % functionalised graphene (Elicarb graphene powder; Thomas Swan & Co Ltd UK Product No. PR0953), which was dispersed in the polyurethane prior to slot die processing. More specifically, prior to dispersion, the graphene was treated with a plasma treatment of “oxygen” functionalisation using the Hydale HDLPAS process, which is set out in WO 2010/142953 A1 (alternatively, plasma functionalised graphene nanoplatelets are commercially available from Hydale “HDPLAS GNP” e.g. HDPlas GNP-O₂ or HDPLAS GNP-COOH). Following treatment, the graphene and polyurethane are premixed in a planetary centrifugal mixer and the resin was degassed under vacuum to remove air bubbles. The mixture was then passed through a dispersion stage using a Three Roll mill (at 40° C. with a <5 μm gap) and with eight passes. The graphene/polyurethane mixture was then mixed with a hardener, followed by subsequent degassing using a planetary centrifugal mixer.

Once the graphene/polyurethane mixture was created it was layered down onto a polypropylene sheet with a 20 μm drawdown wire rod (which regulates the thickness to 20 μm). After the layering down has been completed, the layer was left to dry out. However, before the graphene/polyurethane layer fully cures, the aerogel is stuck onto the layer so as to bond the layers together. The combined layers making up the structure were then left to cure for 24 hours, and after which the combined layer of aerogel and the polyurethane/graphene resin mixture was cut into shape.

An ultra-high molecular weight polyethylene (UHMWPE) fabric (Spectra 1000; 200D; Honeywell; 80 gsm; Warp Yarn 24 Tex; Weft Yarn 25 Tex; Encs×Picks/10 cm 177×177; Plain Weave) was cut to the same size as the backing structure and was applied to the upper surface of the backing structure (i.e. the exposed surface of the polyurethane layer).

The composite structure was then further built up by adding additional, alternating layers of the graphene layers and aerogel layers, together with UHMWPE fabric between each pair of graphene and aerogel layers to form a multi-layered composite. This process was repeated to provide a multi-layered composite comprising 90 layers comprising 30 aerogel layers, 30 graphene/polyurethane layers and 30 UHMWPE layers with the repeating structure: UHMWPE/graphene layer/aerogel layer. The layers of the composite were bonded together.

This composite structure was both flexible and lightweight and therefore can be used as a cable. The composite structure also provided effective protection against damage.

### Example 2

Using the techniques described in respect of Example 1, above, a composite structure comprising 26 layers of UHMWPE fibre (DOYENTRONTEX Bulletproof unidirectional sheet; WB-674; 160 g/m²; 0.21 mm thickness) alternating with 25 layers of backing structure was prepared. The backing structure comprised 125 μm flexible polyimide aerogel (AeroZero 125 micrometer film from BlueShift Inc (US)) layered with a 20 μm layer of a polyurethane (PX60; Xencast UK) (i.e. 25 layers of aerogel alternating with 25 layers of polyurethane). In this Example, the polyurethane was infused with 0.2% graphene (Elicarb graphene powder; Thomas Swan & Co Ltd UK Product No. PR0953) using the technique set out in respect of Example 2. Thus, the composite had the following repeating pattern arrangement of layers “ . . . UHMWPE layer/polyurethane+graphene layer/aerogel layer/UHMWPE layer/polyurethane+graphene layer/aerogel layer . . . ”.

### Example 3

Using the techniques described in respect of Example 1, above, a composite structure comprising 26 layers of UHMWPE fabric (Spectra 1000; 200D; Honeywell; 80 gsm; Warp Yarn 24 Tex; Weft Yarn 25 Tex; Encs×Picks/10 cm 177×177; Plain Weave), 25 layers of 125 μm flexible polyimide aerogel (AeroZero 125 micrometer film from BlueShift Inc (US)) and 25 layers of a 20 μm layer of a polyurethane (PX60; Xencast UK) doped with 1% graphene (Elicarb graphene powder; Thomas Swan & Co Ltd UK Product No. PR0953). Thus, the laminate had the following repeating pattern arrangement of layers “ . . . UHMWPE layer/polyurethane+graphene layer/aerogel layer/UHMWPE layer/polyurethane+graphene layer/aerogel layer . . . ”.

### Example 4

A composite structure 1101 is shown in FIGS. 14a (top view) and 14b (underside view). The composite structure 1101 comprises a repeating structure comprising an aerogel film (125 μm flexible polyimide aerogel; AeroZero 125 micrometer film from BlueShift Inc (US)), a graphene particle infused epoxy (Elicarb graphene powder; Thomas Swan & Co Ltd UK Product No. PR0953) and a high-tensile polyoxymethylene (POM) layer (Delrin). Thus, the composite structure 1101 has a sub-unit of aerogel/graphene-infused epoxy/POM which repeats throughout the structure to form a composite having alternating graphene and aerogel containing layers.

The composite structure 1101 is manufactured by firstly functionalising the graphene nanoplatelets in a Haydale plasma reactor (using a carboxyl process) and subsequently dispersing the graphene nanoplatelets in a flexible epoxy. The graphene/epoxy mixture was subsequently slot die coated onto the Aerogel film and then layered with the POM layer (in the form of a fabric). This sub-unit is then vacuum-cured at room temperature. The structure was then built up by bonding multiple sub-units together on top of one another to form the composite structure 1101. In this way, an aerogel layer of one sub-unit was bonded to a POM layer of an adjacent sub-unit. Furthermore, the lowermost sub-unit of the composite structure 1101 was provided with a POM layer on its underside so that POM layers form the uppermost and lowermost layers.

The composite structure 1101 was flexible, strong and light and thus provides an excellent composite for use in aerospace and/or vehicle skin applications. The composite structure 1101 shown (dimensions 143 mm×193 mm) had a weight of 61 g, whereas a comparative example of similarly-sized (with the exception of thickness) carbon-fibre aerospace composite having similar properties weighed 514 g. The comparative carbon-fibre aerospace composite panel was 4× thicker than the prototype panel; however, even scaling the composite structure 1101, the comparable weight of the composite structure would have been 244g, or less than half the weight of the carbon fibre aerospace composite, with improved properties.

### Example Modifications

It will be appreciated that modifications can be made to the above examples to optimize the desired properties. For example, if it is desirable to increase the conductivity of the first (graphene-containing) layer(s) composite material, the amount of graphene relative to polymer could be increased. Alternatively, the polymer could be removed, and the graphene applied with no matrix (e.g. as platelets or particles in an ink or using any other suitable method) or as planar graphene layers (e.g. by thin-film deposition of any other suitable method).

Although the invention has been described with reference to specific embodiments and examples above, it will be appreciated that modifications can be made to the embodiments and examples without departing from the invention. For example:

the conductive member and the collecting member may be different portions of the same component, element or member or, alternatively, may be separate elements or members;

the collecting element may be any component able to draw electricity from the atmosphere, including, for example, antenna, exposed conductive surfaces of the composite (e.g. which may take the form of apertures through other layers), metal rods and other similar devices; and

additional layers (beyond those referred to above) may be provided.

1-19. (canceled)

20. A device for collecting electricity from the atmosphere, comprising:
a collecting element adapted to draw electricity from the atmosphere;
a support member capable of holding the collecting element in an elevated position; and
an electrically conductive element electrically connected to the collecting element for transmitting electricity collected by the collecting element to an output, wherein the electrically conductive element comprises a composite structure extending at least partially along its length, the composite structure comprising a first layer comprising graphene.

21. The device of claim 20, wherein the composite structure further comprises a second layer comprising an aerogel.

22. The device of claim 21, wherein the composite structure comprises between 2 and 250 first layers and 2 and 250 second layers.

23. The device of claim 20, wherein the composite structure comprises a plurality of alternating layers of graphene and aerogel.

24. The device of claim 23, wherein at least one of the graphene layers consists essentially of graphene.

25. The device of claim 23, wherein at least one of the graphene layers comprises graphene platelets.

26. The device composite structure of claim 22, wherein each first layer independently has a thickness of from 0.34 nm to 20 μm.

27. The device composite structure of claim 22, wherein each second layer independently has a thickness of 20 μm to 1000 μm.

28. The device of claim 20, wherein the composite structure further comprises a support layer.

29. The device of claim 28, wherein the support layer has a tensile strength greater than the tensile strength of the other layers of the composite structure.

30. The device of claim 29, wherein the support layer comprises carbon nanotube (CNT) fibres.

31. The device of claim 20, wherein the device comprises a conductive member which comprises both the collecting element and the electrically conductive element.

32. The device of claim 20, wherein the electrically conductive element extends from the collecting element to the ground.

33. The device of claim 20, wherein the electrically conductive element comprises a terminal portion for connecting to the output and wherein the composite structure extends from the collecting element to the terminal portion.

34. The device of claim 20, further comprising an energy storage device, wherein the electrically conductive element is electrically connected to the energy storage device so as to transfer at least a portion of the electricity collected from the atmosphere to the energy storage device.

35. The device of claim 34, wherein the energy storage device is capacitor array or an ultra-capacitor array.

36. The device of claim 20, wherein the support member is a lift-providing support member.

37. The device of claim 36, wherein the lift-providing support member is an inflatable member.

38. A method of collecting electricity from the atmosphere, the method comprising:
providing a device according to claim 20;
drawing electricity from the atmosphere using the collecting element; and
transmitting electricity collected by the collecting element along the electrically conductive element to an output.

39. The method of claim 38, further comprising providing a plurality of alternating layers of graphene and aerogel extending at least partially along the length of the electrically conductive element.
